(19) United States
(12) Patent Application Publication
(10) Pub. No.: US 2004/0182715 A1
(43) Pub. Date: Sep. 23, 2004

(54) Process and apparatus for air bubble removal during electrochemical processing

(76) Inventors: Jeffrey Bogart, Los Gatos, CA (US); Hung-Ming Wang, San Jose, CA (US); Serkan Erdemli, Manhattan Beach, CA (US); Serdar Aksu, Mountian View, CA (US); Erol C. Basol, Manhattan Beach, CA (US); Manuel R. Cornejo, Stockton, CA (US); Bulent M. Basol, Manhattan Beach, CA (US)

Correspondence Address: NUTOOL, INC, LEGAL DEPARTMENT, 1655 MCCANDLESS DRIVE, MILPITAS, CA, 95035, US

(21) Appl. No.: 10/692,953

(22) Filed: Oct. 24, 2003

Related U.S. Application Data
(60) Provisional application No. 60/456,166, filed on Mar. 20, 2003.

(51) Int. Cl. C25D 5/08; B23H 5/00; B23H 3/00; C25D 11/04

(52) U.S. Cl. 205/133; 205/668; 205/670; 205/324

(57) ABSTRACT

A method for removing gas bubbles from a surface of a wafer is provided. Removal process is performed as the wafer surface is placed into a process solution for an electrochemical process. As the wafer surface is placed into the solution and moved towards a pressure barrier placed into the solution, a process solution flow between the wafer surface and the pressure barrier is induced to remove gas bubbles from the wafer surface. The pressure barrier includes openings which allow process solution to flow through the pressure barrier

### RELATED APPLICATIONS

This application claims priority from Provisional Application Serial No. 60/456,166 filed Mar. 20, 2003 (NT-292 P)which is incorporated herein by reference.

### FIELD

The present invention generally relates to semiconductor processing technologies and more particularly to a semiconductor wafer wet processing system.

### BACKGROUND

In the semiconductor industry, various processes can be used to deposit or remove materials on or from the surface of wafers. Electrochemical deposition (ECD) process can be used to deposit conductors, such as copper, on previously patterned wafer surfaces to fabricate device interconnect structures. Once the conductor such as copper is plated on the wafer surface to fill various features such as trenches and vias, excess copper often need to be removed.

Chemical mechanical polishing (CMP) is commonly used for this material removal step. Another technique, electropolishing or electroetching, can also be used to remove excess materials from the surface of the wafers. Electrochemical (or electrochemical mechanical) deposition of materials on wafer surfaces or electrochemical (or electrochemical mechanical) removal of materials from the wafer surfaces are collectively called “electrochemical processing”. Electrochemical processing techniques include, but are not limited to, electropolishing or electroetching, electrochemical mechanical polishing or electrochemical mechanical etching, electrochemical deposition and electrochemical mechanical deposition.

As generally exemplified in FIG. 1, an ECD system 10 contains a chamber 12 including an electrode 14. The electrode is used as an anode for the deposition processes. However, the electrode may also be polarized as a cathode, if an electroetching or electropolishing process is employed. A carrier head 16 having a rotatable shaft 17 holds a wafer 18 in a process solution 20, which is delivered to the chamber 12 through a solution inlet 21. The solution leaves the chamber 12 from an upper end 23 of the chamber in the direction of arrow A for recycling. For example, for copper deposition, the wafer is usually a preprocessed wafer having features or cavities on the surface. During a process, which may be a deposition or electropolishing process, the wafer is lowered into the process solution 20 and rotated while a potential difference is applied between the wafer 18 and the electrode 14. The potential difference is applied by a power supply, which is connected to the electrode and the conductive wafer surface using suitable electrical contacts (not shown).

One difficulty in such a process is that as the wafer is lowered into the process solution, air bubbles 22 may be trapped under the wafer 18. If the process is a deposition process for copper, for example, air bubbles prevent copper from depositing onto the bubble-containing regions on the wafer surface, giving rise to un-plated or under-plated areas, which represent defects in the plated material. Such defects reduce the reliability of the interconnect structures. Similarly, in an electropolishing process, trapped bubbles retard material removal from the regions containing the bubbles, giving rise to non-uniformities and defects and cause reliability problems.

In the prior art, various techniques are used to eliminate bubbles trapped under the wafers during entry into process solutions. One such known method requires tilting the carrier head 16 as it enters the process solution to let the bubbles escape. However this approach requires expensive carrier head designs, which increase manufacturing cost.

Therefore, to this end, there is a need for alternative bubble elimination designs and processes, which can be employed during electrochemical processing of a workpiece such as a wafer.

### SUMMARY

The present invention provides a pressure building barrier for removing gas bubbles trapped under a wafer surface. The pressure building barrier includes openings which allow process solution to flow through the pressure building barrier when the pressure building barrier is placed into the process solution. The pressure building barrier includes a porous filter or a flow enhancement plate or a combination of both. The flow enhancement plate includes channels to direct process solution flow. The wafer surface to be processed towards the pressurebuilding barrier, at least during the early stages of the process. The solution that is compressed between the wafer surface and the porous barrier moves outwardly away from the center of the wafer towards its edge. This solution flow and the resulting sweeping action dislodges and sweeps away the bubbles that may be trapped under the wafer surface.

One aspect of the present invention includes a method for removing gas bubbles from a semiconductor wafer surface during or before the electrochemical process. The wafer surface is placed in a process solution for the electrochemical process. In the method, a barrier surface having one or more openings is placed into the process solution and the process solution is flowed through the one or more openings of the barrier surface. The wafer surface is immersed into the process solution and moved towards the barrier surface to induce a process solution flow between the wafer surface and the barrier surface to remove gas bubbles from the wafer surface.

Another aspect of the present invention includes a system for removing gas bubbles from a semiconductor wafer surface before of during an electrochemical process. The wafer surface is placed in a process solution for the electrochemical process. In the system, a wafer carrier holds and moves the wafer. A pressure barrier having one or more openings immersed into the process solution. The one or more openings allow a process solution flow through the pressure barrier. When the wafer surface is immersed into the process solution and moved towards the barrier surface, the pressure barrier increases the velocity of the process solution flow between the workpiece surface and the pressure barrier and thereby sweeps the bubbles away with the process solution.

Other aspects and advantages of the invention will become apparent from the following detailed description, taken in conjunction with the accompanying drawings, illustrating by way of example the principles of the invention.

### BRIEF DESCRIPTION OF THE DRAWINGS

FIG. 1 is a schematic illustration of a conventional electrochemical deposition system;

FIG. 2A is a schematic illustration of an embodiment of an electrochemical deposition system of the present invention, showing example bubbles as the workpiece makes contact with the solution surface;

FIG. 2B is a schematic illustration of the electrochemical deposition system shown in FIG. 2A, wherein the trapped bubbles have been removed with the help of the apparatus and process of the present invention;

FIG. 3 is a schematic illustration of another embodiment of the electrochemical deposition system of the present invention;

FIG. 4 is a detailed schematic illustration of the porous pressure-building barrier and the flow enhancement plate of the system shown in FIG. 3;

FIG. 5 is a schematic top view of an upper plate of the flow enhancement plate shown in FIG. 4; and

FIG. 6 is a schematic top view of the lower plate of the flow enhancement plate shown in FIG. 4.

### DESCRIPTION

The method and apparatus of the present invention will be described for an electroplating system. It should be understood that the invention may also be applied to the wet material removal methods such as electropolishing techniques.

The present invention moves the wafer surface to be processed towards a porous pressure-building barrier, at least during the early stages of the process. The solution that is compressed between the wafer surface and the porous barrier moves outwardly away from the center of the wafer towards its edge. This solution flow and the resulting sweeping action dislodges and sweeps away the bubbles that may be trapped under the wafer surface.

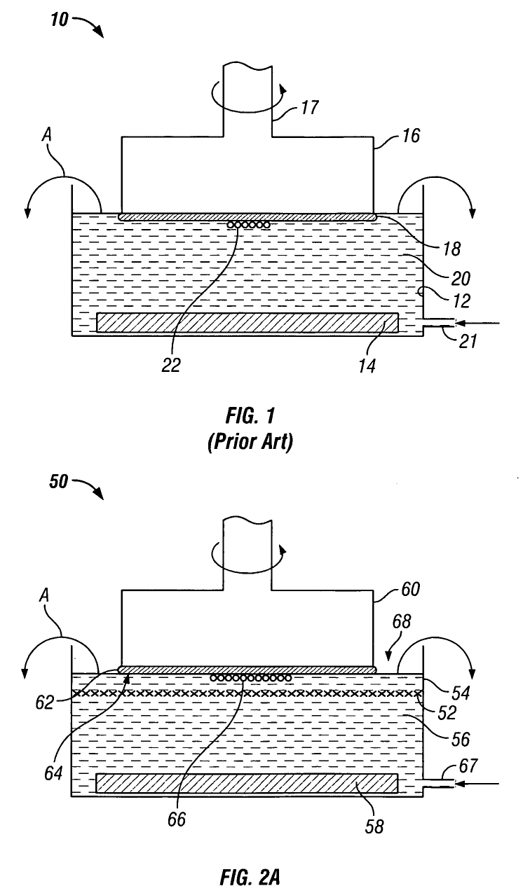

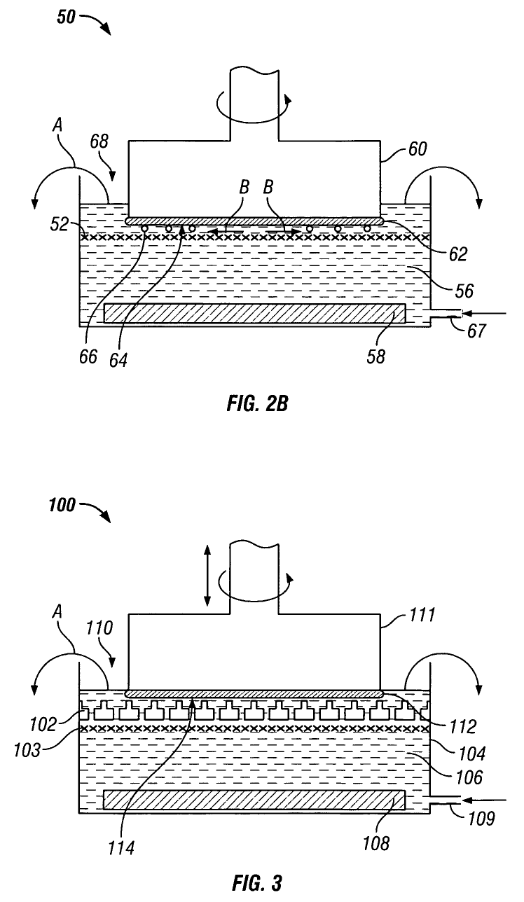

FIGS. 2A-2B illustrate an ECD system 50 of the present invention, which uses a porous pressure-building barrier 52. The system 50 includes a chamber 54 containing a process solution 56 and an electrode 58 immersed into the solution 56. A carrier head 60 holds a wafer 62 and exposes a surface 64 of the wafer to the process solution 56. The carrier head 60 can be rotated and moved laterally as well as vertically (z-motion) by a moving mechanism (not shown). The carrier head 60 can be rotated and laterally moved during the selected process steps. The process solution enters the chamber 54 through a solution inlet 66 and leaves the chamber for recycling or discarding from an upper end 68 of the chamber as depicted by arrow A. An exemplary process solution for electrodeposition may include copper sulfate based acidic solution, which is available from companies such as Shipley and Enthone. Further, an exemplary electropolishing solution may be a phosphoric acid based electropolishing electrolyte.

The porous pressure-building barrier 52 may be made of a porous insulating material such as a filter material, a porous ceramic or polymeric piece or it may be a plate with small holes drilled through it. Generally, a pore size in the range of 10 to 500 microns is preferred. The porosity of the pressure-building barrier should be such that when wafer surface is moved in “z” direction towards the porous pressure-building barrier in the process solution, the pressure increase in the region between the wafer surface and the porous pressure-building barrier should cause a high lateral flow of the process solution from under the wafer surface as will be described later.

During the process, the wafer is lowered onto the process solution and in proximity of the porous pressure-building barrier. FIG. 2A exemplifies the instant when bubbles appear under the surface 64, as the wafer is lowered into the process solution. As soon as the wafer surface contacts the surface of the solution 56, bubbles 66 may be trapped due to various reasons such as non-flat wafer surface or non-flat solution surface.

As exemplified in FIG. 2B, however, as the downward motion of the wafer continues and the wafer is further lowered towards the porous layer, the solution body gets squeezed between the pressure-building barrier 52 and the surface 64 of the wafer and it flows out of this region while sweeping the bubbles away from the surface 64. In this case, it is assumed that the small pore size of the porous pressure-building barrier 52 does not allow, or allows only a minimum amount of solution to flow or to diffuse down through the pressure-building barrier 52. Therefore, the solution flow direction depicted by arrows B in FIG. 2B is substantially in a direction parallel to the surface of the wafer. Small pore size in the barrier and high downward velocity of the wafer surface generate a high-velocity solution flow, which can efficiently sweep the bubbles. However, if the pore size in the barrier gets larger, some flow may diffuse down through the porous barrier and then rise up to the upper end 68 of the chamber, which is near the edge of the wafer. As can be appreciated this may lower the horizontal flow velocity under the wafer and reduce efficiency of bubble sweeping. A consequence of large pore size in the barrier would be that the solution flow coming from inlet 66 would go preferentially towards the upper ends 68 of the chamber, rather than under the wafer when the wafer is placed into the solution. A barrier with small pores increases and equilibrates the fluid pressure under the barrier within the chamber 54 and thus the flow above the barrier becomes uniform. This way when the wafer comes down it can effectively squeeze the solution.

If the wafer is lowered into the solution towards the pressure-building barrier at very low speeds, the lateral velocity of the squeezed solution under the wafer surface would be low reducing the sweeping efficiency. After the bubble elimination step, the wafer may be retracted away from the porous pressure-building barrier to initiate plating process.

Alternatively, the plating process may be initiated right after the bubble elimination process. In this embodiment, to perform bubble elimination process, a preferred distance between the surface of the wafer and the porous pressure-building barrier may be in the range of 0.5 to 20 millimeters, most preferably between 0.5 to 2 millimeters. Further, a solution flow velocity may be in the range of approximately 1 to 5 meter/second. This may require for the wafer surface to move towards the pressure-building barrier at a speed of 10-50 mm/sec or higher.

In another example, a flow enhancement plate may replace the porous pressure-building barrier or may be used together with the porous pressure-building barrier. The flow enhancement plate helps both bubble elimination process as well as stabilizing the process solution during lateral motion of the wafer. The flow enhancement plate may have grooves or channels or openings in them to allow the process solution to pass. The channels may face the wafer surface so that the solution pushed against the flow enhancement plate is flowed along these channels in high velocity.

In terms of bubble removal, the high-velocity solution flow generated in the channels and under the surface of the wafer sweeps out the possible bubble accumulation under the surface. If the size of the openings in the channels are small enough to allow the solution to be squeezed between the plate and the wafer surface, the flow enhancement plate may be used alone, without the porous pressure-building barrier. The flow enhancement plate may also be used with the porous pressure-building barrier. In that case, the flow enhancement plate may be placed above the porous barrier or attached on top of it.

FIG. 3 illustrates an exemplary ECD system 100 of the present invention, which uses a flow enhancement plate 102 placed above a porous pressure-building barrier 103. In this embodiment, except the flow enhancement plate, the rest of the components of the system 100 are in compliance with the system 50 described above. However for the sake of clarity, in the description of this embodiment, different reference numerals are used. The system 100 includes a chamber 104 containing a process solution 106 and an electrode 108 immersed into the solution 106. The process solution 106 can be delivered to the chamber 104 through a solution inlet 109. The solution 106 leaves the chamber for recycling or discarding from an upper end 110 of the chamber as depicted by arrow A. A carrier head 111 holds a wafer 112 and exposes a surface 114 of the wafer 112 to the process solution. The carrier head 111 can be rotated and moved in z-direction. During the process, the wafer is lowered into the process solution 106 and toward the flow enhancement plate 102. The surface 114 of the wafer is disposed in proximity of the flow enhancement plate 102.

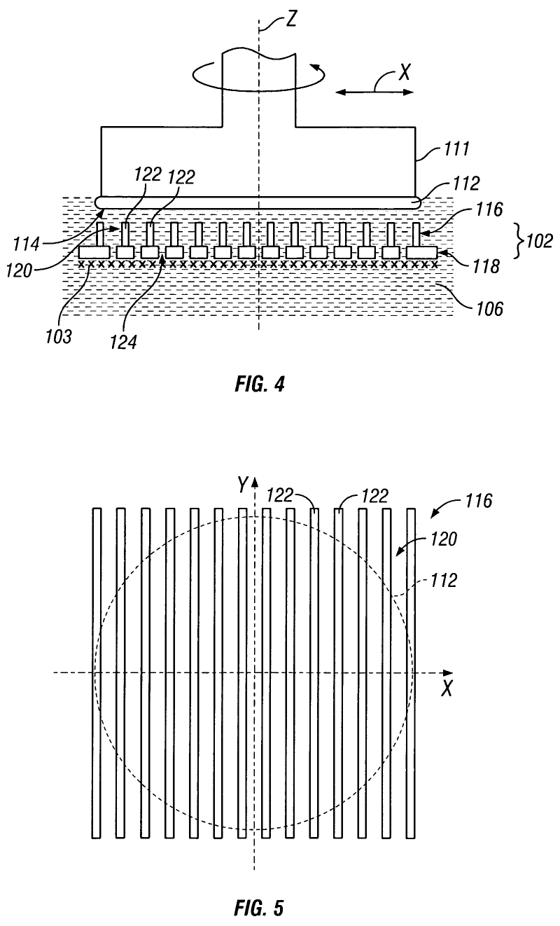

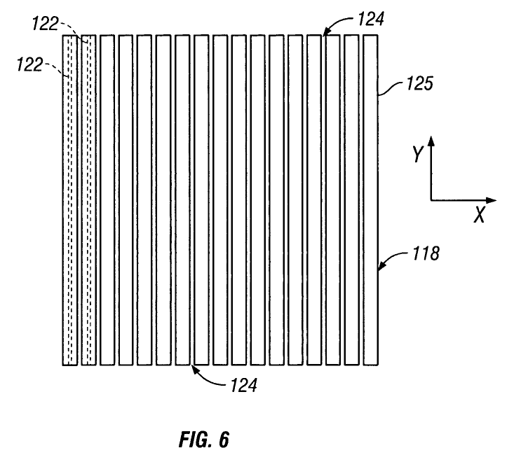

FIG. 4 shows the flow enhancement plate 102 in detail. The flow enhancement plate 102 may comprise an upper plate 116 and a lower plate 118. The upper and lower plates of the flow enhancement plate 102 may also be manufactured as a single integrated piece. The upper plate 116 includes a plurality of channels 120 which are defined by side-walls 122. The side-walls of the channels 120 may be substantially parallel to one another and to the z-axis of the carrier head 111 or they may be slightly slanted. The side-walls of the channels may have any shape. The width of the channels may also vary. FIG. 5 shows the upper plate 116 in plan view with a circle depicting the location of the wafer 112 (dotted circle). As shown in FIG. 4 the channels 120 extends along the y-direction. The channels 120 do not need to fully cover the upper plate 116. The channels may be constructed close to a region of the wafer that is prone to trap more bubbles, such as the center of the wafer. In one alternative embodiment, the porous pressure-building barrier may be placed between the upper and lower plates 116, 118 respectively. Further, the channels on the upper plate may be curved, evenly spaced or not evenly spaced. Channels distributed with various angles or shapes over the upper plate are within the scope of this invention.

The lower plate 118 may comprise openings 124 to pass process solution 106. As shown in FIG. 6, the openings 124 may be slits extending in the y-direction between strips 125 of the lower plate 118. Position of the side walls 122 on the strips 125 is shown on two of the strips with dotted lines. In this embodiment, the slits 124 extend along the channels 120 and aligned with the channels in the same direction. The slits are disposed parallel to one another and the width of the slits may be less than the width of the channels. A filter may be placed between the electrode and the lower plate or between the lower plate and the upper plate, preferably under the lower plate, to prevent any particles or gas bubbles from reaching the surface of the wafer. However, although in this invention, the primary function of the porous pressure-building barrier is building pressure in the solution body, it may have a secondary function to act as a filter thereby negating the need for a separate filter.

Before the process, the process solution is filled into the chamber and flowed against the porous pressure building-barrier. The solution then passes through the porous pressure-building barrier, rises through the openings of the lower plate and fills the channels 120. The solution level is kept above the upper plate so that no contact between the upper plate and the surface of the wafer occurs during the process.

Referring to FIG. 3, during the process, as the wafer 112 is lowered into the solution 106, the process solution is moved against the upper plate. This solution moving against the upper plate 116 generates a solution flow in the channels 120. In general, without the side walls the solution flow could occur in all lateral directions including in the x and y-directions. Presence of side-walls, however, restricts the flow especially the flow in the x-direction which is perpendicular to the side-walls of the upper plate 116. However, the flow in y-direction or in other directions with small angles with y-direction, moves along the channels 120 and the solution flow in the y-direction continues unrestricted, and at a higher velocity than the case shown in FIG. 2B where there was no upper plate. In other words, presence of channels defined by side-walls directs the lateral solution flow mostly along the channels and increases the flow velocity of this solution and its efficiency to sweep any trapped bubbles under the wafer surface.

As mentioned above the flow enhancement plate also stabilizes the process solution during lateral motion of the wafer 112. Referring to FIG. 5, as the wafer moves above the channels 120 in a lateral fashion for example in x-direction, waves generated by the movement are stabilized by the side-walls 122 of the channels 120. In a sense, the side-walls 122 of the channels 120 act like wave-breakers and prevent sloshing of the process solution as the wafer moves in the x-direction. To be able to stabilize the moving of the process solution, however, the angle between the direction of the lateral motion and the side-walls of the channels must be larger than 0 degree, preferably close to 90 degrees. A preferred range of angles is 30-90 degrees. As also mentioned above, the same upper plate may include channels with the same or different shapes. These channels may also be distributed with various angles over the upper plate. In such case, each channel or the sections of each channel may establish a different angle with the direction of the lateral motion and stabilizes the process solution.

During electroplating, the upper plate may contact the surface of the wafer to mechanically sweep the surface to obtain a planar depositing film as in some techniques aiming to obtain relatively flat copper topography on patterned wafer surfaces. In this case, the upper surface of the upper plate may include a pad material to mechanically sweep the surface during the process. An exemplary technique that can reduce, or totally eliminate, copper surface topography for all feature sizes is the Electrochemical Mechanical Processing (ECMPR). This technique has the ability to provide thin layers of planar conductive material on the wafer surfaces, or even provide a wafer surface with no or little excess conductive material. This way, a planarization process step using CMP can be minimized or even eliminated. The term “Electrochemical Mechanical Processing (ECMPR)” is used to include both Electrochemical Mechanical Deposition (ECMD) processes as well as Electrochemical Mechanical Etching (ECME), which is also called Electrochemical Mechanical Polishing (ECMP). It should be noted that in general both ECMD and ECME processes are referred to as electrochemical mechanical processing (ECMPR) since both involve electrochemical processes and mechanical action on the wafer surface.

Descriptions of various ECMPR approaches and apparatus, can be found in the following patents, published applications and pending applications, all commonly owned by the assignee of the present invention: U.S. Pat. No. 6,126,992 entitled “Method and Apparatus for Electrochemical Mechanical Deposition,” U.S. application Ser. No. 09/740,701 entitled “Plating Method and Apparatus that Creates a Differential Between Additive Disposed on a Top Surface and a Cavity Surface of a Workpiece Using an External Influence,” filed on Dec. 18, 2001 and published as U.S. patent application on Feb. 21, 2002 with patent application No. 20020020628, and U.S. application filed on Sep. 20, 2001 with Ser. No. 09/961,193 entitled “Plating Method and Apparatus for Controlling Deposition on Predetermined Portions of a Workpiece”. U.S. application with Ser. No. 09/960,236 filed on Sep. 20, 2001, entitled “Mask Plate Design.” U.S. application Ser. No. 10/155,828 filed on May 23, 2002 entitled “Low Force Electrochemical Mechanical Processing Method and Apparatus.”

Although various preferred embodiments and the best mode have been described in detail above, those skilled in the art will readily appreciate that many modifications of the exemplary embodiment are possible without materially departing from the novel teachings and advantages of this invention.

We claim:

1. A method for removing gas bubbles from a workpiece surface which is placed in a process solution for an electrochemical process, the method comprising:
placing a barrier surface having one or more openings into the process solution;
flowing the process solution through the one or more openings of the barrier surface;
immersing the workpiece surface into the process solution; and
moving the workpiece surface towards the barrier surface to induce a process solution flow between the workpiece surface and the barrier surface to remove gas bubbles from the workpiece surface.

2. The method of claim 1 further comprising placing the workpiece surface in proximity of the barrier surface subsequent to the step of moving.

3. The method of claim 2, wherein the distance between the workpiece surface and the barrier surface is 0.5 to 20 millimeters.

4. The method of claim 1 further comprising touching the barrier surface with the workpiece surface subsequent to the step of moving.

5. The method of claim 1, wherein the barrier surface is adapted to have channels to direct and increase the velocity of the flow of process solution between the workpiece surface and the barrier surface.

6. The method of claim 1, wherein the electrochemical process is an electrochemical deposition of a conductive material onto the surface of the workpiece.

7. The method of claim 1, wherein the electrochemical process is electrochemical removal of a conductive material from the surface of the workpiece.

8. The method of claim 1, further comprising rotating the workpiece surface during the step of immersing;

9. The method of claim 1, further comprising laterally moving the workpiece surface in proximity of the barrier surface.

10. The method of claim 1, further comprising initiating the electrochemical process during the step of immersing.

11. The method of claim 1, wherein the step of moving occurs during the electrochemical processing.

12. The method of claim 1, wherein the step of moving occurs before the electrochemical processing is initiated.

13. The method of claim 1, wherein during the step of moving, the flow of process solution has a velocity of 1 to 5 meters per second.

14. The method of claim 1, wherein during the step of moving the workpiece surface is moved towards the barrier surface with a velocity of 10 to 50 millimeters per second.

15. The method of claim 1, wherein the workpiece surface and the barrier surface are substantially parallel to one another.

16. A system for removing gas bubbles from a surface of a workpiece which is placed in a process solution for an electrochemical process, comprising:
a workpiece carrier to hold the workpiece;
a pressure barrier having one or more openings immersed into the process solution, the one or more openings allowing a process solution flow through the pressure barrier, wherein when the surface of the workpiece is immersed into the process solution and moved towards the barrier surface, the pressure barrier increases the velocity of the process solution flow between the surface of the workpiece and the pressure barrier and thereby sweeps the bubbles away with the process solution.

17. The system of claim 16, wherein the pressure barrier is a porous layer.

18. The system of claim 16, wherein the pressure barrier is a filter material having porosities.

19. The system of claim 16, wherein the pressure barrier has channels facing the surface of the workpiece to direct the process solution flow on the pressure barrier.

20. The system of claim 19, wherein the process solution flow is directed laterally and parallel to the surface of the workpiece.

21. The system of claim 16, wherein the pressure barrier is a flow enhancing plate having channels to direct the process solution flow on the pressure barrier.

22. The system of claim 21, wherein the pressure barrier is a flow enhancing plate having channels to direct the process solution flow on the pressure barrier and a filter material placed under the flow enhancing plate.

23. The system of claim 21, wherein the center of the pressure barrier is placed below the center of the surface of the workpiece.

24. The system of claim 22, wherein the center of the pressure barrier is placed below the center of the surface of the workpiece.

25. The system of claim 21, further comprising a pad layer attached on the barrier surface to sweep the surface of the workpiece during the electrochemical process.

26. The system of claim 16, wherein the workpiece is a semiconductor wafer.
